(19) United States
(12) Patent Application Publication
(10) Pub. No.: US 2007/0071295 A1
(43) Pub. Date: Mar. 29, 2007

(54) Orientation-based assessment of cardiac synchrony in medical imaging

(75) Inventor: John I. Jackson, Menlo Park, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/237,507

(22) Filed: Sep. 27, 2005

(51) Int. Cl. G06K 9/00

(52) U.S. Cl. 382/128

(57) ABSTRACT

Cardiac synchrony information is provided for medical imaging. Multidimensional motion is determined, such as by tracking tissue locations of the heart through a sequence of images. An approximate orientation of the heart is identified. The identification may be automatic or performed by a processor. A component of the multidimensional motion relative to the orientation of the heart is extracted and used to generate a display. By separating out longitudinal, radial and/or circumferential motion relative to the heart, synchrony or asynchrony may be detected more easily.

### BACKGROUND

The present embodiments relate to assessment of cardiac synchrony in medical imaging. An emerging consideration for the treatment of some people who have heart failure is whether or not the person's heart is contracting in a coordinated, synchronous way. Current methods of evaluation include assessment of echocardiographic M-mode images, pulsed-wave and continuous-wave Doppler, tissue Doppler, and strain rate imaging. Pulsed-wave Doppler or tissue Doppler indicates motion along scan lines. The one-dimensional motion may be angle corrected, such as correcting motion based on a user input of a motion angle. These methods all have some limitations, including their sensitivity to the position of the ultrasound transducer relative to the heart. The Doppler methods compute velocity relative to the location of the imaging transducer. The acquired velocity information may be misleading. Tissue Doppler images acquired from near the apex of the heart give approximate information about the longitudinal velocity of the heart walls, but determining inward, or radial velocity has not been possible from this view. Doppler methods also require additional time to turn on and optimize the image acquisition parameters.

### BRIEF SUMMARY

By way of introduction, the preferred embodiments described below include a methods, systems and instructions for the assessment of cardiac synchrony in medical imaging. Multidimensional motion is determined, such as by tracking tissue locations of the heart through a sequence of images. An approximate orientation of the heart is identified. The identification may be automatic or performed by a processor. A component of the multidimensional motion relative to the orientation of the heart is extracted and used to generate a display. By separating out longitudinal, radial and/or circumferential motion relative to the heart, synchrony or asynchrony may be detected.

In a first aspect, a method is provided for the assessment of cardiac synchrony in medical imaging. Multidimensional motion is determined for at least one location on heart tissue of a heart. A processor identifies an approximate orientation of the heart. A one-dimensional component of the multidimensional motion relative to the orientation is determined.

In a second aspect, a system for the assessment of cardiac synchrony in medical imaging includes a processor. The processor is operable to determine multidimensional motion for at least one location of a heart and operable to determine a one-dimensional component of the multidimensional motion relative to an approximate orientation of the heart. A display is operable to display an image as a function of the one-dimensional component.

In a third aspect, a computer readable storage medium has stored therein data representing instructions executable by a programmed processor for the assessment of cardiac synchrony in medical imaging. The instructions are for tracking locations associated with a heart through a sequence of ultrasound images, and computing, for each location, a component of motion as a function of the tracking, the component being relative to a general orientation of the heart.

In a fourth aspect, a method is provided for the assessment of cardiac synchrony in medical imaging. Motion is determined for at least one location on heart tissue of a heart. The motion is normalized over at least a portion of a heart cycle. An image is displayed as a function of the normalized motion.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram of one embodiment of a method for the assessment of cardiac synchrony analysis in medical imaging;

FIG. 2 is a graphical representation of one view of a heart for determining orientation;

FIGS. 3 and 4 are example images showing a longitudinal and radial velocity component timing, respectively, of heart motion;

FIG. 5 shows alternative displays longitudinal and radial velocity components;

FIG. 6 is a block diagram of one embodiment of a system for the assessment of cardiac synchrony in medical imaging; and

FIG. 7 is another graphical representation of one view of a heart for determining orientation.

### DETAILED DESCRIPTION OF THE DRAWINGS AND PRESENTLY PREFERRED EMBODIMENTS

Myocardial-motion timing analysis incorporates information about the orientation and/or position of the heart. The result is information about the longitudinal, radial, and/or circumferential motion of the heart. An ultrasound or other mode image can be obtained from the window near the apex of the heart, and both longitudinal and radial velocities are computed. Furthermore, because the timing of the contraction is important, the motion timing information overlays on an image in one embodiment. In other embodiments, the image includes individual components of the velocity which vary over time. This motion may be normalized by a peak value (over time) at each location, so that the time to fractional amounts of the peak velocity of a specific piece of myocardium is more easily identified.

A localized motion vector is estimated by tracking points or regions of an ultrasound or other image. The motion vector represents displacement, velocity, strain and/or strain rate. A component of the motion in a direction aligned with the orientation of the heart is computed. The component or a summary of the component (e.g., timing) is displayed in a parametric, graphical or numerical way, or is saved in a memory. The time from a physiologic event, such as the R-wave or the aortic valve opening, until a fractional amount of the peak motion is achieved, such as the time to the peak velocity, or the time to 50% of the peak velocity, may indicate an amount of synchrony. By normalizing to the peak motion of the component, synchrony may be more easily identified, more likely allowing the clinician to distinguish and quantify the performance of the heart walls.

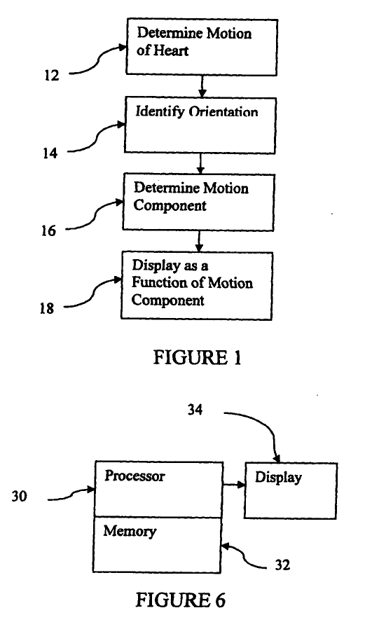

FIG. 1 shows a method for the assessment of cardiac synchrony in medical imaging. The method uses ultrasound, such as B-mode ultrasound (echocardiography) images. Alternatively, a time-series of magnetic resonance imaging (MRI) images, high-speed computed tomography (CT) images, or anatomical imaging techniques that produce a time series of images from which motion can be derived may be used. The method is applied to two-dimensional (planer) or three-dimensional (volume) data sets. Each data set represents the heart or portion of the heart at a generally different time, such as a sequence of two-dimensional ultrasound images. The method may include additional, different or fewer acts. For example, act 18 is not performed or act 18 is performed but the motion component is stored in a memory. The same or different order of the acts than shown may be used.

In act 12, a multidimensional motion is determined for at least one location on heart tissue of a heart. The heart tissue is a heart wall, inner wall, outer wall, valve or other heart tissue. In one embodiment, motion is determined for a plurality of locations, such as for a point or region corresponding to seven or more heart wall segments. In another embodiment, motion is determined for a line representing the heart wall. The locations are identified for tracking by the user or automatically. For example, the user selects different points in an image or draws a line through or along the heart wall (e.g., traces a line along the middle or an edge of the myocardial wall). As another example, a processor performs automatic border detection of the heart wall and places locations for motion determination regularly along the border. As another example, the user indicates one or more initial locations, tissue structure or region of interest, and the processor identifies other locations based on the user indication.

The multidimensional motion is determined by tracking the locations as a function of time. A series of images or data sets represent planes or volumes of the heart at different times in a same or different heart cycle. After identifying the locations in an initial data set, the points or regions corresponding to the locations are tracked through the cardiac cycle or a portion of the cardiac cycle. Cardiac wall motion is tracked using, at least in part, ultrasound B-mode information, but other ultrasound or non-ultrasound data may be used. Speckle, feature, border, motion based, combinations thereof or other tracking may be used. For example, U.S. Pat. No. 6,193,660, the disclosure of which is incorporated herein by reference, tracks regions of interest using speckle information. As another example, U.S. Pat. No. 6,527,717, the disclosure of which is incorporated herein by reference, determines motion by combining B-mode and Doppler data. In another example, U.S. Publication No. 2005/0074153, the disclosure of which is incorporated herein by reference, tracks locations using B-mode based borders, speckle and periodic motion information. Other tracking may be used. In one embodiment, the user manually identifies the locations through a sequence.

By tracking the locations between two or more sets of data from different times, a multidimensional motion is determined. The motion is a two-dimensional vector for planar or 2D imaging or is a three-dimensional vector for volume or 3D/4D imaging. The motion vector represents the motion of the location. The type of motion represented is displacement (distance between the same location of the heart tissue at different times), velocity, strain, strain rate or combinations thereof. The multidimensional motion is localized, representing a point or region of the heart tissue. Different motion vectors representing different points or regions with or without overlap may be determined.

In act 14, an approximate orientation of the heart is identified. Since the orientation may not exactly match the heart orientation due to processing or manual tolerance, the term approximate is used. The orientation of the heart may be for the entire heart, a chamber, a portion of a chamber or other portion of the heart.

The orientation of the heart, such as the direction from the mitral plane to the apex, can be computed for each set of data or from less than all (e.g., the initial set only) the sets of data in the sequence. Where the orientation is identified from different sets of data, the possibly different orientation are used separately for motion derived from the corresponding set of data or the orientations are averaged or otherwise combined.

The general orientation of the heart is identified manually in one embodiment. In another embodiment, a processor identifies the general orientation of the heart. A combination of processor identification with user assistance or manual identification may be used. The orientation is determined the same or differently for different views of the heart. Some embodiments for determining orientation based on a view with the transducer near the apex of the left ventricle are provided below. Extensions of the embodiments below or other embodiments may be used for other cardiac chambers or views.

In one embodiment, the orientation of the heart wall is determined based on the placement of the points or the shape of the region of interest provided for tracking in act 12. A pattern fitting to the points identifies the orientation.

In another embodiment, a shape is fit to the region of interest, set of data or previously determined locations. Simple shapes, such as an ellipse, or more complex shapes, such as a model or expected chamber shape, are fit to the data. A minimum sum of absolute differences, correlation or other measure of similarity indicates a best or sufficient fit. For the simple shape approach, a major axis of the shape is the longitudinal axis of a heart chamber. The minor axis is the radial axis of the heart chamber. For the more complex shape approach, the axes of the heart are determined based on the shape. The longitudinal, radial and circumferential axes are perpendicular, but non-perpendicular axes may be used.

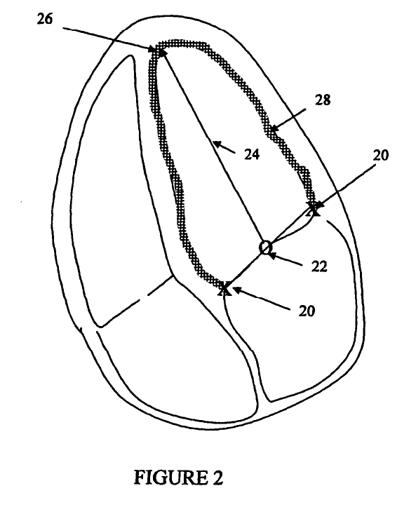

Another embodiment is shown in FIG. 2. FIG. 2 represents the left ventricle at any point in the heart cycle, such as peak systole. Two points 20 at the base of the opposite heart walls 28 are identified automatically or manually. A midpoint 22 of a line connecting the two points 20 is determined. A location 26 on the heart wall 28 furthest away from the midpoint 22 along a line 24 is identified manually or automatically as the apex. The line 24 extending from the midpoint 22 to the apex 26 is the longitudinal axis of the left ventricle. The radial axis of the heart chamber is perpendicular to the longitudinal axis, but may be the possibly non-perpendicular line between the two base points 20.

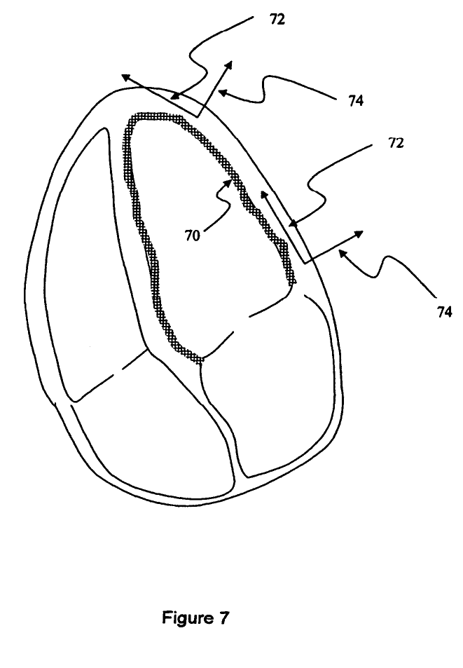

As another embodiment, as shown in FIG. 7, the orientation direction is computed as the localized direction of the region of interest (ROI) 70. For a view of the left ventricle that includes the bases and apex, with a tracking ROI that goes from the base to the apex, the direction parallel to the ROI 70, or the direction parallel to a smoothed version of the ROI, is considered the longitudinal direction 72. The component of the motion in this direction 72 is a longitudinal motion. In a short axis view, the direction parallel to the ROI would be circumferential. In either case, the direction normal to the ROI is the radial direction 74.

In act 16, a one-dimensional component of the multidimensional motion is determined relative to the orientation. Based on the estimated orientation of the heart, the multidimensional motion from act 12 is decomposed into one-dimensional components. The longitudinal, radial, and/or circumferential components of the motion are determined from the multidimensional motion vectors. For example, using a planar image from an apical view, the longitudinal velocity and/or the radial velocity are computed. For a three-dimensional motion vector, two or one-dimensional components are determined.

The heart-oriented components are determined for each of the tracked locations, but a sub-set may be used. The components are determined through the sequence. For example, the motion is tracked through the sequence of images or data sets. The motion may be consistent or vary for a given location throughout the sequence. Similarly, the longitudinal, radial and/or circumferential component of the motion may be consistent or vary throughout the sequence. Different components may have different timings or amounts of variance.

In one embodiment, the one-dimensional components of motion are normalized. Each component is normalized separately. For example, the longitudinal values are divided by the maximum longitudinal value. Each location is normalized separately. For example, the maximum longitudinal value for each location normalizes the other longitudinal values for the respective location. Where the location is a region associated with a plurality of values for a given time, the plurality of values may be averaged or treated separately. In other embodiments, the multidimensional motion is normalized or the maximum for a region or the entire field of view is used. The maximum is determined over the cardiac cycle or a portion of the cardiac cycle, such as mechanical systole. The faster velocities at the base of the ventricle, such as at the level of the mitral valve, and the slower velocities closer to the apex are normalized. Normalization may more likely identify the peak or a fraction of the peak motion.

In act 18, a display is generated as a function of one or more components of motion relative to the heart orientation. The display is an image, text, a graph, a numerical value, a table or other output. For example, a sequence of images of the longitudinal, circumferential, or radial component mapped as a color overlay of a B-mode image is generated. As another example, separate but adjacent displays of two or more of the components are provided.

The display includes or is mapped from the components of motion or displays values derived from the components of motion. In one embodiment, a timing relationship of the one-dimensional component for each of a plurality of the locations is determined. A single parameter, such as the time to the peak velocity or the time to 50% of the peak velocity, is calculated for each location. The peak velocity or other parameter is identified for each location from the component values. The time from a trigger event, such as the ECG R-wave, to the parameter indicates the timing. The time window used for extraction of the parameter may be limited to a portion of the cardiac cycle, such as the time from aortic valve opening to aortic valve closing, or from aortic valve opening to mitral valve opening. The component of motion values may be filtered, such as low pass filtering, in the process of extracting the single parameter.

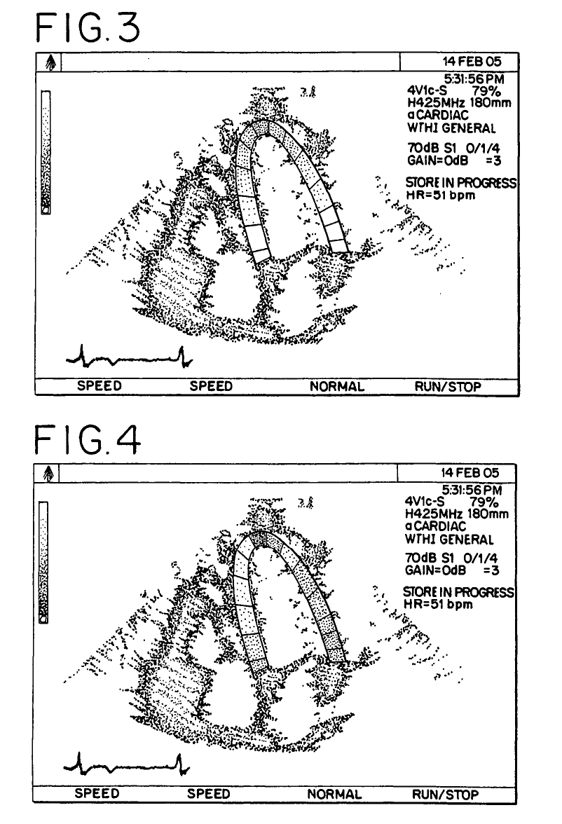

The timing relationship or other parameter is displayed. One or more parameters are displayed for each location. Parameters for a plurality of locations are displayed. FIGS. 3 and 4 show two example images overlaying the derived parameter information on a B-mode ultrasound image. The parameter is the timing of the peak motion through a single heart cycle. FIG. 3 shows the longitudinal velocity, and FIG. 4 shows the radial velocity. The timing values are provided for each of 14 segments of the left ventricle heart wall. The timing values are mapped to a color (e.g., hues of yellow, orange and/or red) or gray scale. FIGS. 3 and 4 are gray scale representations of a gray scale B-mode image with color timing overlays (shown in black and white). The timing values are mapped to region blocks, but may be mapped to points or lines. Color-coding of the B-mode data for each region may be used. In alternative embodiments, the timing values are shown on a graphic representing the heart or a bulls-eye plot. A graph where one axis corresponds with different spatial locations along the heart wall and the other axis is the value of the parameter may be used. A numerical value overlaid or separate from an image may be displayed. For example, numerical values for each of predefined or user-defined regions, such as the ASE standard segments, are provided.

In FIG. 3, the timing of the longitudinal velocities on opposite walls is similar as represented by the similar coloring or shading. The timing of the apex relative to the base is different. The apex may be moving out of synchronization with the base of the wall. In FIG. 4, the opposite walls have different radial timing, indicating asynchronous radial movement. One or more of the timing values may be further highlighted, such as where the timing is sufficiently asynchronous with another timing value or an average timing value.

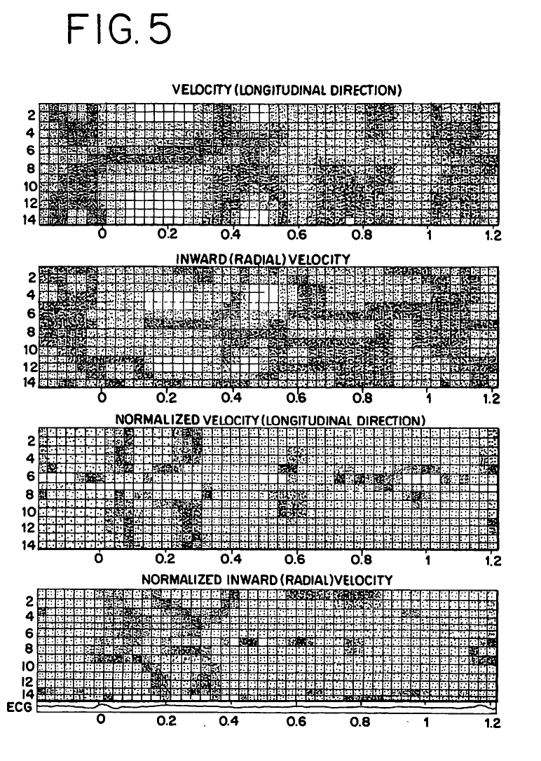

FIG. 5 shows another embodiment for displaying as a function of the components of the motion relative to the heart orientation. One or more components are displayed for at least one location as a function of time. FIG. 5 shows fourteen locations along a vertical axis. Time is shown along the horizontal axis. An associated ECG signal may also be shown to show relative portions of the heart cycle. The motion component values modulate the display values. FIG. 5 shows gray scale modulation, but color may be used. The longitudinal and radial (in-ward/outward) velocity components are shown in separate one-dimensional or M-mode type images. In alternative embodiments, the components modulate overlays for a sequence of two-dimensional images. FIG. 5 also shows longitudinal and radial images from normalized components.

A display with only one image, images for circumferential components, only normalized images, only non-normalized images or other combinations may be used. For example, the normalized longitudinal, radial, and/or circumferential images are displayed adjacent to a B-mode image or a sequence of B-mode images with or without the timing overlays shown in FIGS. 3 and/or 4. Other display formats or mapping may be used.

FIG. 6 shows a system for the assessment of cardiac synchrony in medical imaging. The system implements the method of FIG. 1 or other methods. The system includes a processor 30, a memory 32, and a display 34. Additional, different or fewer components may be provided. For example, a user input is provided for manual or assisted indication of tissue regions or locations. As another example, the system is a medical diagnostic ultrasound imaging system that also includes a beamformer and a transducer for real-time acquisition and imaging. Other medical imaging systems may be used. In another embodiment, the system is a personal computer, workstation, PACS station or other arrangement at a same location or distributed over a network for real-time or post acquisition imaging.

The processor 30 is a control processor, general processor, digital signal processor, application specific integrated circuit, field programmable gate array, network, server, group of processors, data path, combinations thereof or other now known or later developed device for determining one-dimensional components of motion relative to the orientation of the heart. For example, the processor 30 or a data path of processors including the processor 30 determines multidimensional motion for at least one location of a heart. The processor 30 tracks a plurality of locations as a function of time. The multidimensional motion for each location is a function of the tracking. The motion is a velocity, a displacement, a strain, a strain rate or combinations thereof representing two or three dimensional motion vectors. The processor 30 determines a one-dimensional component of the multidimensional motion relative to an orientation of the heart. The processor 30 identifies the orientation as a function of a shape fitting to a heart chamber, a base and apex of the heart chamber, the motion of the at least one location or other process. The longitudinal, radial, and/or circumferential component of the motion is determined. The components may be normalized by the processor 30.

The processor 30 operates pursuant to instructions stored in the memory 32 or another memory. The processor 30 is programmed for estimating a speckle value or values for an image and/or extracting tissue regions.

The memory 32 is a computer readable storage media. The instructions for implementing the processes, methods and/or techniques for the assessment of cardiac synchrony in medical imaging discussed above are provided on the computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

In one embodiment, the instructions are for tracking locations associated with a heart through a sequence of ultrasound images, computing, for each location, a component of motion as a function of the tracking where the component is relative to an orientation of the heart, and generating an image as a function of the component for each location.

The memory 32 may store alternatively or additionally medical image data for generating images. The medical data is ultrasound, MRI, CT or other medical imaging data. The medical data is of display values or data prior to mapping for display.

The display 34 is a CRT, LCD, projector, plasma, or other display for displaying one or two dimensional images, three dimensional representations, graphics, numerical values, combinations thereof or other information. The display 34 receives display values from the processor 30. An image is generated as a function of one or more one-dimensional components. For example and as shown in FIG. 5, the image displays the locations as a function of time modulated by a longitudinal, circumferential or radial component of the motion. As another example and as shown in FIGS. 3 and 4, the image displays a timing relationship of the one-dimensional component for each of a plurality of the locations relative to the heart cycle.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for the assessment of cardiac synchrony in medical imaging, the method comprising:
determining multidimensional motion for at least one location on heart tissue of a heart;
identifying, with a processor, an approximate orientation of the heart; and
determining a one-dimensional component of the multidimensional motion relative to the orientation.

2. The method of claim 1 wherein determining the multidimensional motion comprises tracking a plurality of the locations as a function of time

3. The method of claim 1 wherein identifying the orientation comprises fitting a shape to a region of interest, a major axis of the shape being a longitudinal axis of a heart chamber.

4. The method of claim 1 wherein identifying the orientation comprises determining a midpoint of a line across a base of a heart chamber and connecting the midpoint with a heart wall location furthest from the midpoint in the heart chamber, the midpoint to heart wall location being a longitudinal axis.

5. The method of claim 4 wherein identifying the orientation comprises determining a radial axis of the heart chamber as perpendicular to the longitudinal axis.

6. The method of claim 1 wherein identifying the orientation comprises identifying the orientation as a function of a direction of a region of interest.

7. The method of claim 1 wherein determining the multidimensional motion comprises determining, from B-mode ultrasound data, a two or three dimensional motion at a plurality of locations along a heart wall.

8. The method of claim 1 wherein determining the component of the multidimensional motion relative to the orientation comprises determining a longitudinal component of the motion, a radial component of the motion, or a circumferential component of the motion.

9. The method of claim 1 wherein determining the multidimensional motion comprises determining a velocity, a strain, a strain rate or combinations thereof.

10. The method of claim 1 further comprising:
displaying the at least one location as a function of time modulated by the one-dimensional component.

11. The method of claim 10 wherein the displaying comprises displaying a plurality of the locations as a function time modulated in a first image by a longitudinal component and modulated in a second image by a radial component.

12. The method of claim 10 further comprising:
normalizing the one-dimensional component.

13. The method of claim 1 further comprising:
determining a timing relationship of the one dimensional component for each of a plurality of the locations; and
displaying the timing relationship for each of the locations.

14. A system for the assessment of cardiac synchrony in medical imaging, the system comprising:
a processor operable to determine multidimensional motion for at least one location of a heart and operable to determine a one dimensional component of the multidimensional motion relative to an approximate orientation of the heart; and
a display operable to display an image as a function of the one-dimensional component.

15. The system of claim 14 wherein the processor is operable to track a plurality of the locations as a function of time, the multidimensional motion for each location being a function of the tracking and being a velocity, a displacement, a strain, a strain rate or combinations thereof in two or three dimensions.

16. The system of claim 14 wherein the processor is operable to identify the orientation as a function of a shape fitting to a heart chamber, a base and apex of a the heart chamber, or the direction of a region of interest.

17. The system of claim 14 wherein the processor is operable to determine a longitudinal component of the motion, a radial component of the motion, or a circumferential component of the motion.

18. The system of claim 14 wherein the image is of the locations as a function of time modulated by a longitudinal, circumferential or radial component of the motion.

19. The system of claim 18 wherein the processor is operable to normalize the one-dimensional component.

20. The system of claim 14 wherein the image is of a timing relationship of the one-dimensional component for each of a plurality of the locations relative to the heart cycle.

21. In a computer readable storage medium having stored therein data representing instructions executable by a programmed processor for the assessment of cardiac synchrony in medical imaging, the storage medium comprising instructions for:
tracking locations associated with a heart through a sequence of ultrasound images; and
computing, for each location, a component of motion as a function of the tracking, the component being relative to a general orientation of the heart.

22. The instructions of claim 21 further comprising:
generating an image as a function of the component for each location.

23. A method for the assessment of cardiac synchrony in medical imaging, the method comprising:
determining motion for at least one location on heart tissue of a heart;
normalizing the motion over at least a portion of a heart cycle; and
displaying an image as a function of the normalized motion.
